(19) United States
(12) Patent Application Publication
(10) Pub. No.: US 2026/0274013 A1
(43) Pub. Date: Sep. 17, 2026

(54) PNEUMATIC TYRE FOR A TWO-WHEELED VEHICLE

(71) Applicant: Continental Reifen Deutschland GmbH, Hannover, DE (US)

(72) Inventors: Daniel Lengemann, Korbach (DE); Artur Zipf, Twistetal (DE); Waldemar Drews, Korbach (DE); Arne Siemers, Garbsen (DE)

(73) Assignee: Continental Reifen Deutschland GmbH, Hannover (DE)

(21) Appl. No.: 19/469,525

(22) PCT Filed: Mar. 7, 2024
(86) PCT No.: PCT/DE2024/200012

§ 371 Date: Sep. 26, 2025

(30) Foreign Application Priority Data
Mar. 31, 2023 (DE) 10 2023 202 990.1

(51) Int. Cl. B60C 15/06

(52) U.S. Cl. CPC B60C 15/06; B60C 2015/0614; B60C 2200/10; B60C 2200/12

(57) ABSTRACT

A two-wheeler pneumatic tire having a tread, a tire carcass, tire sidewalls and two bead regions each having a tire bead with a core, wherein the two bead regions have in each case a bead protection strip which as wear protection is disposed axially outside the carcass;

wherein two carcass ply turn-ups are disposed in the zenith of the tire so as to overlap one another, wherein the carcass ply turn-ups extend over the zenith and the tire sidewalls into both bead regions, and in the latter terminate below the bead protection strip in a first carcass ply end.

### CROSS-REFERENCE TO RELATED APPLICATIONS

This application is a National Stage Application under 35 U.S.C. § 371 of International Patent Application No. PCT/DE 2024/200012 filed on Mar. 7, 2024 and claims priority from German Patent Application No. 10 2023 202 990.1 filed on Mar. 31, 2023, the disclosures of which are herein incorporated by reference in their entireties.

### BRIEF SUMMARY

The invention relates to a two-wheeler pneumatic tire, preferably a bicycle tire, in particular racing bike tire, mountain bike tire, gravel bike/CX tire, or pedelec or e-bike tire, having a tread, a tire carcass, tire sidewalls and two bead regions each having a tire bead with a core, wherein the two bead regions have in each case a bead protection strip which as wear protection is disposed axially outside the carcass, wherein the tire carcass is formed from a first carcass ply and a second carcass ply, each having a strength member, wherein the second carcass ply is disposed in a zenith of the two-wheeler pneumatic tire so as to be radially within the first carcass ply, and extends from the zenith of the two-wheeler pneumatic tire over the tire sidewalls into both bead regions, and in the latter wraps the respective core from axially inside to axially outside, and terminates in a second carcass ply end below the bead protection strip of the respective bead region, wherein the first carcass ply extends from the zenith of the two-wheeler pneumatic tire over the tire sidewalls into the bead regions, and in the latter wraps the respective core from axially inside to axially outside, wherein the first carcass ply leads from the respective bead region in a carcass ply turn-up over the respective tire sidewall and under the tread, and wherein the two carcass ply turn-ups are disposed in the zenith of the tire so as to overlap one another.

Conventional two-wheeler pneumatic tires, preferably bicycle tires, are designed and optimized in terms of rolling resistance, puncture protection and mileage. There is, to some extent, a conflict of objectives between these characteristics.

For example, EP 3 174 738 A1 discloses a racing bike tire having a two-ply carcass, wherein turn-ups of both carcass layers largely cover the sidewalls. Such a tire, at least in a part of the sidewall, is reinforced by four plies of the carcass. The construction enables a high degree of cutting resistance for the sidewall. However, the extensive use of carcass material in the region of the sidewall has an adverse effect on weight and rolling resistance.

A typical construction with a single-ply carcass is known from W02019/025953 A1, for example, and distinguished by the fact that the turn-ups of the carcass ply extend as far as into the tire zenith and terminate below the tread so as to overlap one another. Such a construction is easy to produce but exhibits lower cutting resistance in the sidewall and thus exhibits lower puncture resistance in the sidewall.

DE202020104281U1 discloses a tire having a two-ply carcass, wherein the carcass turn-ups of both carcass layers terminate under the bead protection strip. Such a tire is optimized in terms of rolling resistance but exhibits low puncture protection.

A generic two-wheeler pneumatic tire is disclosed in DE 10 2021 201 322 A1, which has a two-ply carcass and whose carcass turn-ups overlap one another while reaching beyond the tire zenith, so that a three-ply carcass composite is present in the tire sidewalls and a four-ply composite is present in the region of the tire zenith. This construction offers a good balance between rolling resistance and puncture protection. For a training tire (AllSeason), however, cutting and puncture protection is the highest priority.

The invention is based on the object of providing a two-wheeler pneumatic tire, preferably a bicycle tire, in which puncture resistance is improved while maintaining good rolling resistance, which is nevertheless inexpensive to produce and is also tubeless-ready and also can be driven on hookless rims.

The object is achieved in that the carcass ply turn-ups extend over the zenith and the tire sidewalls into both bead regions, and in the latter terminate below the bead protection strip in a first carcass ply end.

One advantage of the two-wheeler pneumatic tire according to the invention is to be seen in particular in that the puncture resistance is substantially improved by the new tire construction, while producibility remains good. Compared to the state of the art, in particular according to DE 10 2021 201 322 A1, the tire construction remains the same except for the additional material width of the carcass plies, but this significantly increases puncture protection. According to the invention, four plies of the carcass plies are continuously present in the sidewall as well as below the tread, formed by an overlapping arrangement of the first and second carcass plies and two further plies formed by the carcass turn-ups. At the same time, the tire displays good rolling resistance.

It is essential to the invention that the first carcass ply leads from the respective bead region in a carcass ply turn-up over the respective tire sidewall below the tread, and from there over the opposite sidewall into the contiguous bead region to a first carcass ply end, and there terminates in the respective first carcass ply end below the bead protection strip. At the same time, the second carcass ply terminates in its second carcass ply ends also below the bead protection strip, and thus does not lead from the respective bead region over the tire sidewalls to below the tread.

The tire has two axial halves. In this way, in both of the axial halves of the tire a carcass ply turn-up extending from the bead region in the direction of the zenith, and a carcass ply turn-up extending from the zenith to the carcass ply end, are in each case disposed so as to overlap one another in the region of the tire sidewalls, as a result of which, conjointly with the plies formed by the first and the second carcass ply, a reinforcement of each sidewall is provided by four plies of the carcass. The first carcass ply contributes three plies and the second carcass ply contributes one ply. The design of the side walls with four plies has the effect of substantially improving the cutting resistance of the sidewall in comparison to a carcass in which the sidewall is reinforced by only two or three plies.

The reinforcement of the sidewall by four plies of the carcass does indeed lead to increased wear due to friction and to an additional input of material in terms of carcass material. However, the conflict of objectives between puncture resistance of the sidewall and rolling resistance is resolved at a high level in favor of puncture resistance, which is the focus of particular attention for a puncture-resistant training tire.

Owing to the fact that the first carcass ply ends are disposed below the bead protection strip, the former are at the same time protected against delamination. This further improves durability and puncture resistance of the two-wheeler tire.

Owing to the two carcass plies being wrapped about the core, the new construction makes it possible both to maintain a simple tire construction and to advantageously protect the core against damage, in particular in comparison to a carcass that has only one carcass ply.

It has thus been demonstrated that a two-wheeler tire, preferably a bicycle tire, with the construction according to the invention, resolves the conflict of objectives between puncture resistance, in particular puncture resistance of the sidewall, and rolling resistance at a high level in favor of puncture resistance.

At the same time, owing to the fact that the second carcass ply ends are disposed below the respective bead protection strip, the construction according to the invention furthermore makes it possible to eliminate any direct connection between a tire interior and a tire exterior by way of one of the two carcass plies. Likewise, with the second carcass ply ends, the strength members of the second carcass ply that terminate there are covered from the outside by the bead protection strip. This avoids or greatly reduces an escape of air from the tire interior through the two carcass plies, in particular during tube-free operation, as a result of which a high degree of air-tightness of the tire, in particular during tube-free operation, is furthermore made possible.

The first carcass ply terminates in the first carcass ply ends below the bead protection strip. The first carcass ply ends can thus be disposed spatially in the region of a bead between the bead protection strip and a carcass ply turn-up, and spatially in the region of the other bead between the first carcass ply and the associated carcass ply turn-up, so that the two-wheeler pneumatic tire according to the invention is of an asymmetrical design in the region of the carcass ply ends.

The second carcass ply terminates in the second carcass ply ends below the bead protection strip of the respective bead region. The second carcass ply ends can in each case be disposed spatially between the respective bead protection strip and a carcass ply turn-up, or between a first carcass ply end and a carcass ply turn-up in the bead region.

The bead protection strip serves as usual as a wear protection in relation to a rim flange during the operation of the tire, and thus reduces the risk of the carcass strength members being exposed. The bead protection strip can assist in forming, or form, an outer surface of the bead region that is conceived as a contact surface to the rim. The bead protective strip can cover the respective second carcass ply end from axially outside.

The first carcass ply and the second carcass ply have in each case, as usual, two strength members which run parallel to one another and are embedded in an elastomer material. Here, the strength members conjointly with the revolving direction U can, as usual, enclose an angle of 40 degrees to 60 degrees. The strength members of the first carcass ply and of the second carcass ply can have opposing angles of inclination.

Advantageous refinements of the invention will be explained hereunder.

The tire has two axial halves. In an advantageous embodiment of the invention, it is provided that in each of the axial halves a carcass ply turn-up extending from the bead region in the direction of the zenith, and a carcass ply turn-up extending from the zenith to the carcass ply end, are in each case disposed so as to overlap one another in the region of the tire sidewalls.

The two carcass ply turn-ups thus overlap continuously over both sidewalls and in the zenith of the tire. The first carcass ply ends are in each case situated in the other axial half as the starting point of the respective carcass ply turn-up that ends in the respective first carcass ply end. The carcass ply turn-ups thus extend over both axial halves of the two-wheel pneumatic tire according to the invention. Therefore, axially between the two first carcass ply ends of the first carcass ply, continuous reinforcement is provided by four plies of the carcass. The first carcass ply is triple and the second carcass ply is single. While such a construction can have an adverse effect on rolling resistance, the cutting resistance of the tire in the region of the sidewalls and of the tread is greatly improved, this resulting in a significantly improved puncture resistance of the tire according to the invention. This is particularly important for all-season tires and for training tires for racing bikes.

In this way, a two-wheeler pneumatic tire which, while using a small input of strength members, specifically only two carcass plies, guarantees an advantageous puncture protection on the sidewalls and below the tread, is made available.

According to a further proposal of the invention, the first carcass ply ends, or at least one carcass ply end, terminate(s) in the bead regions below the second carcass ply ends.

As a result, the cutting resistance in the region of the side walls is still guaranteed and protection of the first carcass ply ends against delamination is improved yet again, since the first carcass ply ends are situated below both the bead protection strips as well as the second carcass ply ends. As a result of the asymmetrical construction in the bead region, the first carcass ply end is also additionally disposed below the carcass ply turn-up in a bead region.

In an advantageous refinement of the invention, the bead protection strip terminates in a radially outer end at a first height of at most 15 mm, preferably of 10 mm to 12 mm, measured relative to an outermost turn-up point of the strength members of the second carcass ply that are wrapped about the core.

Owing to this low disposal of the bead protection strip as well as the associated low disposal of the second carcass ply ends, the turn-ups of the second carcass plies are primarily disposed in a region which experiences barely any or no cyclic deformation during the operation of the tire. Thus, the friction-induced energy losses of the second carcass ply can be further reduced. Likewise, the input of material for the bead protection strip and for the second carcass ply, and thus the weight of the tire, are advantageously reduced.

In order to determine a height in the bead region, in particular the first height or the second height mentioned below, the two-wheeler pneumatic tire can be curved upwards in terms of its cross section in such a way that the two carcass plies emanating from the zenith are disposed so as to be largely rectilinear in the region of the sidewall, and transition to a wrapping of the core that is largely symmetrical in terms of the core. In this arrangement, the respective height, measured relative to the outermost turn-up point of an outer edge of the strength members of the second carcass ply that are wrapped about the core, is measured parallel to the largely rectilinear carcass plies. If the bead protection strip comprises fibers, in particular a woven fabric, then the fibers, in particular the selvedge of the woven fabric, can define the radially outer end of the bead protection strip. Correspondingly, the first carcass ply end and the second carcass ply end can be formed by ends of the strength members, in particular by a selvedge, of the respective carcass ply.

Corresponding advantages relating to the second carcass ply can be achieved if the second carcass ply ends are disposed below the bead protection strip at a second height of at most 13 mm, preferably of 8 mm to 10 mm, measured relative to an outermost turn-up point of the strength members of the second carcass ply that are wrapped about the core.

Corresponding advantages are also achieved when the second carcass ply ends terminate in the respective bead region, in particular before the sidewall while emanating from the core.

The bead protection strip can be embodied as a rubberized strip comprising fibers, in particular as a rubberized woven fabric strip. The woven fabric strip can be a woven nettle fabric or a woven nylon fabric.

In a further advantageous refinement of the invention, the bead protection strip is free from threads which comprise intertwined fibers and which connect a radially outer end of the bead protection strip and an inner end of the bead protection strip.

In a further advantageous refinement of the invention it is provided that the bead protection strip is embodied as a rubberized woven monofilament fabric.

The rubberized woven monofilament fabric is particularly effective in reducing air leakage at the tire/rim contact region, in particular more effective than a customary bead protection strip with a woven fabric comprising threads of a plurality of intertwined fibers. The reason is that the monofilaments are embedded largely individually in the rubber coating, and any escape of air from the tire interior to the tire exterior via microchannels between the fibers of the threads of the bead protection strip is thus substantially avoided.

This enables the tire assembled on a rim to be particularly airtight. This is advantageous in particular for a tube-free tire. Operating the tire without a tube can therefore be made possible without further complex measures such as an inner liner, for example, the latter often worsening the rolling resistance.

The bead protection strip, which is embodied as a rubberized woven monofilament fabric here, can be free of threads comprising intertwined fibers which connect a radially outer end of the bead protection strip and an inner end of the bead protection strip.

In a further advantageous refinement of the invention it is provided that the carcass is in direct contact with a tire interior. This makes it possible to obtain a particularly lightweight tire, and thus an advantageous rolling resistance. For a tube-free tire, in particular a “tubeless-ready” bicycle tire, sufficient air-tightness can be ensured by the measures described, in particular the design of a bead protection strip embodied as a rubberized woven monofilament fabric.

In a further advantageous refinement of the invention it is provided that the tire is a tube-free tire, in particular a “tubeless” tire or a “tubeless-ready” tire.

Tube-free tires are tires that are suitable for tube-free operation of the tire. Tube-free tires are in particular tires in a tubeless operation. Tube-free tires place increased demands on the airtightness of the tire per se as well as on the seal on the tire/rim contact surface. A system in tubeless operation thus comprises at least the tube-free tire and a rim, wherein the tube-free tire is assembled on the rim, and the system is free of any tube. In the tubeless operation of the tube-free tire, friction losses between tube and tire are absent so that the tire enables an advantageous rolling resistance. Reasons for punctures relating to tubes are likewise dispensed with. When operating a tube-free tire in the tubeless operation, the use of a sealing liquid, in particular a sealant fluid, which is introduced into the tire interior between the tire and the rim, can improve the tightness.

A tube-free tire may be a so-called “tubeless” tire, which is primarily or exclusively suitable and intended for operation without a tube. A tubeless tire can often also be driven without a sealant fluid.

The tube-free tire may also be a so-called “tubeless-ready” tire, which is suitable and intended both for operation with and for operation without a tube. Typically, a tubeless-ready tire is used with a sealing liquid, in particular a sealant fluid, in tubeless operation. The tire and rim herein can be constructed so as to seal directly in relation to one another.

The invention is particularly advantageous for tube-free bicycle tires, in particular tube-free racing bike tires or tube-free mountain bike tires.

In a further advantageous refinement of the invention, it is provided that the tire is a bicycle tire suitable and intended for operation with a tube, in particular a clincher tire. A system operated with a tube thus comprises at least the bicycle tire and a rim, wherein the bicycle tire is installed on the rim, and a substantially air-tight tube is arranged in a tire interior that is enclosed by the tire and the rim. When a tire is operated with a tube, the air pressure is maintained by means of a largely air-tight tube disposed in the tire interior between the tire and the rim. Here, too, the new tire construction permits advantageously increased puncture protection.

A so-called clincher tire is typically a wire-based tire or a folding tire. The tire in this instance has a wire core, or a folding core, and is hooked to the rim flange of the rim by way of the bead. A clincher tire is easy to assemble and disassemble using simple means. In the event of a puncture, the damage can thus be easily repaired.

In a further advantageous development of the invention, at least in one region of the sidewall, the two carcass plies, that is to say the first carcass ply and the second carcass ply, are the only plies with strength members. By dispensing with a further ply which has strength members, a particularly thin and therefore lightweight region of the sidewall, with optimized rolling resistance, is made possible.

In a further advantageous development of the invention, a damping rubber ply from a highly elastic natural rubber is disposed between the tread and the tire carcass, wherein the damping rubber ply has in particular a material thickness between 0.2 mm and 1 mm.

Greater ride comfort and better rolling resistance are thereby made possible by decoupling the woven fabric plies. The ride comfort of the bicycle tire is significantly improved owing to the special material thickness of the damping rubber ply, since the bicycle tire overall is better able to adapt to the road surface. Furthermore, the additional rubber ply enhances the puncture protection in the zenith.

The damping rubber ply can preferably be composed of a highly elastic natural rubber with a material rebound value between 70 and 80. Optimum ride comfort is achieved with this material rebound value, the rolling resistance of the tire not being simultaneously increased.

In a further advantageous refinement of the invention, a protective ply from a particularly tear-resistant rubberized woven fabric, preferably a particularly tear-resistant rubberized woven fabric comprising fibers of polyethylene terephthalate polyacrylate, or from a rubber layer, is disposed between the tread and the tire carcass.

The protective ply ensures optimum puncture protection in the zenith for the two-wheeler pneumatic tire, preferably the bicycle tire. The particularly tear-resistant rubberized woven fabric comprising fibers of polyethylene terephthalate polyacrylate can be a rubberized woven fabric which comprises Vectran fibers or is composed of the latter. The rubber layer can have a thickness of at most 6 mm, measured in a radial direction in the tire zenith.

In a further advantageous further refinement of the invention it is provided that this is a bicycle tire, in particular a racing bike tire, a gravel/CX tire, a mountain bike tire, or a tire for a bicycle having an electric motor for driving the bicycle. The novel tire construction is however suitable for use in all types of bicycles.

The tire construction according to the invention can be used in racing bike tires. A racing bike tire usually has a maximum tire width of 35 mm and exhibits a racing bike-specific low profile of the tread.

The tire construction according to the invention, in particular for tube-free tires, is also ideally suited to gravel/CX tires and mountain bike tires. Gravel and CX tires typically have a minimum tire width of 32 mm, in particular 40 mm, and often have a pronounced profile of the tread. Mountain bike tires typically have a minimum tire width of 45 mm, in particular 60 mm, and have a strongly pronounced profile of the tread. Aspects such as the rolling resistance combined with high puncture protection are also becoming increasingly important for these profiled tires. In particular, a tubeless operation of the tire can be advantageous, because in this instance the susceptibility to punctures is reduced and such a tire can be used at a comparatively lower air pressure.

The new tire construction is also ideally suited for use on bicycles having an electric motor for driving the bicycle. In such use, high puncture protection is advantageous because it increases the reliability of the bicycle.

The tire can be a tire for an electric bicycle. A tire for an electric bicycle can satisfy the test standard “ECE R75”. The specific suitability for an electric bicycle is often indicated by the designation “E-bike ready 50”.

The tire can also be a tire for a pedelec, in which propulsion is at least partially assisted by the electric motor. Specific suitability for a pedelec is often indicated by the designation “E-bike ready 25”.

In a further advantageous refinement of the invention it is provided that the tire is a motorcycle tire, in particular an electric scooter tire. A motorcycle tire or an electric scooter tire having the new construction can also contribute, by way of the advantageous puncture protection, toward improved reliability of the vehicle.

### BRIEF DESCRIPTION OF THE SEVERAL VIEWS OF THE DRAWINGS

Further features, advantages and details of the invention will now be explained in more detail with reference to the schematic drawings illustrating an exemplary embodiment. In the drawings:

FIG. 1 shows a two-wheeler pneumatic tire according to the invention in cross section; and

FIG. 2 shows a fragment of the two-wheeler pneumatic tire in cross section.

### DETAILED DESCRIPTION

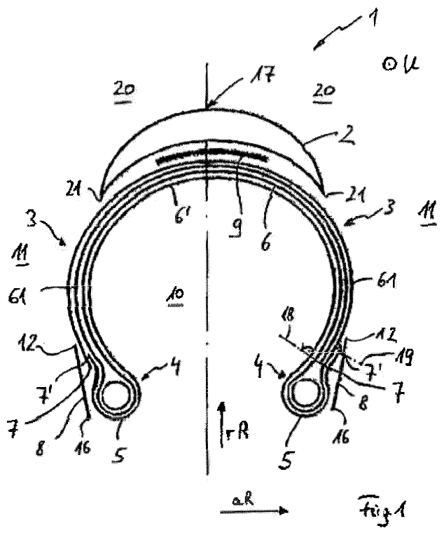

FIG. 1 shows the substantial tire components of a two-wheeler pneumatic tire 1 in a cross-sectional view. This is a two-wheeler pneumatic tire 1, preferably bicycle tire, having a tread 2, a tire carcass, tire sidewalls 3 and two bead regions 4 each having a tire bead with a core 5, wherein the two bead regions 4 have in each case a bead protection strip 8 which as wear protection is disposed axially outside the carcass.

The tire carcass is formed from a first carcass ply 6 and a second carcass ply 6′, each having strength members. The strength members within the respective carcass ply here are typically disposed so as to be mutually parallel and at an angle of 40 degrees to 60 degrees relative to the revolving direction U. The strength members of the two carcass plies 6, 6′ can have opposing angles of inclination. The tire 1 has two axial halves 20, which are symmetrical with respect to one another at least in terms of the carcass plies 6, 6′.

The second carcass ply 6′ is disposed in a zenith 17 of the tire 1 so as to be radially within the first carcass ply 6. Said second carcass ply extends from the zenith 17 of the two-wheeler pneumatic tire 1 over the tire sidewalls 3 into both bead regions 4, and in the latter wraps the respective core 5 from axially inside to axially outside, and terminates in a second carcass ply end 7′ below the bead protection strip 8 of the respective bead region 4.

The first carcass ply 6 extends from the zenith 17 of the tire 1 over the tire sidewalls into the bead regions 4, and in the latter wraps the respective core from axially inside to axially outside.

The two-wheeler pneumatic tire 1 is distinguished in that the first carcass ply 6 leads from the respective bead region 4 in a carcass ply turn-up 61 over the respective tire sidewall 3 below the tread 2, and over the axially opposite sidewall up to a first carcass ply end 7, and there terminates in the first carcass ply end 7 below the bead protection strip 8. In this way, in both axial halves 20 of the two-wheeler pneumatic tire 1, in the region of the sidewalls 3, in particular radially between the second carcass ply end 7′ and a tread end 21, reinforcement of the sidewall 3 is provided by four plies of the carcass, wherein the first carcass ply 6 contributes three plies, and the second carcass ply 6′ contributes one ply.

The second carcass ply 6 terminates in the first carcass ply ends 7 below the bead protection strip 8 and radially below the second carcass ply end 7′. The first carcass ply end 7, which terminates in the left axial half 20 in the illustration, lies spatially between the bead protection strip 8 and the first carcass ply turn-up 61. The first carcass ply end 7, terminating in the right axial half 20 in the illustration, in contrast lies spatially between the carcass ply turn-up 61 and the first carcass ply 6. A first straight line 18, aligned perpendicularly to the second carcass ply 6′, extends radially below a second straight line 19, aligned perpendicularly to the carcass ply turn-up 61.

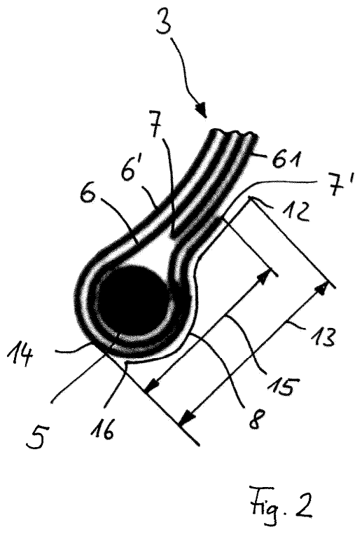

The bead protection strip 8 can terminate in a radially outer end 12 at a first height 13 of at most 15 mm, preferably of 10 mm to 12 mm, measured relative to an outermost turn-up point 14 of an outer edge of the strength members of the second carcass ply 6′ that are wrapped about the core 5. Alternatively or additionally, the second carcass ply ends 7′ of the second carcass ply 6′ can be disposed at a second height 15 of at most 13 mm, preferably of 8 mm to 10 mm, measured relative to an outermost turn-up point 14 of the strength members of the second carcass ply 6′ that are wrapped about the core 5. Dimensions of the first height 13 and of the second height 15 are highlighted in FIG. 2. The bead protection strip 8 is embodied as a rubberized strip comprising fibers, in particular as a rubberized woven fabric strip.

The fibers, in particular the selvedge of the woven fabric, can define the radially outer end 12 of the bead protection strip 8. In particular for tubeless operation, the bead protection strip 8 can be free of threads which comprise intertwined fibers and which connect a radially outer end 12 of the bead protection strip 8 and an inner end 16 of the bead protection strip 8. In FIGS. 1 and 2, the bead protection strip 8 is embodied by way of example as a rubberized woven monofilament fabric.

The second carcass ply ends 7′ of the second carcass ply 6′ can terminate in the bead region 4, in particular before the sidewall 3 while emanating from the core 5.

The carcass is in direct contact with the tire interior 10. The tire 1 in particular has no inner liner. Advantages according to the invention can however also be achieved by a two-wheeler pneumatic tire 1 which has a further layer, in particular an inner liner, between tire interior 10 and the carcass.

As illustrated, at least in one region of the sidewall 3, in particular so as to adjoin the bead strip 8 from radially outside, the two carcass plies 6, 6′ can be the only plies comprising strength members.

As illustrated, a damping rubber ply 9 from a highly elastic natural rubber can be disposed between the tread 2 and the tire carcass, wherein the damping rubber ply 9 in particular has a material thickness between 0.2 mm and 1 mm. The damping rubber ply can preferably be composed of a highly elastic natural rubber with a material rebound value between 70 and 80.

A protective ply (not illustrated) comprising an in particular tear-resistant rubberized woven fabric, preferably a rubberized woven fabric comprising fibers made of polyethylene terephthalate-polyacrylate, can be disposed between the tread 2 and the tire carcass. Alternatively, the protective ply can also be formed from a rubber layer with a thickness of at most 6 mm, measured in a radial direction rR in the tire zenith 17.

The tires illustrated are in each case a tube-free tire, in particular a “tubeless” tire or a “tubeless-ready” tire. The tire can be suitable, intended and used for tubeless operation. A tire for operation with a tube, in particular a clincher tire, can however also have an advantageous construction with corresponding features.

The tire illustrated is a racing bike tire. Other tires, in particular gravel, CX and mountain bike tires, or tires for a bicycle having an electric motor for driving the bicycle, can however also be embodied correspondingly. Motorcycle tires, in particular electric scooter tires, can also have the advantageous construction illustrated.

FIG. 1 shows a tire 1 with particularly good puncture resistance. The two first carcass ply turn-ups 61 are disposed so as to overlap one another in the region of the sidewalls 3 as well as in the zenith 17 of the tire 1. Each of the two carcass ply turn-ups 61 extends from a bead region 4 in one axial half 20 of the two-wheeler pneumatic tire 1 over the contiguous sidewall 3 and below the tread 2, and over the opposite sidewall 3, and terminates in the respective first carcass ply end 7 in the respective other axial half 20 of the tire. Thus, in the region of the sidewalls and the zenith 17 of the tire, the tire 1 is reinforced by four plies of the carcass, as illustrated.

FIG. 2 highlights the dimensions of the first height 13 and of the second height 15. In order to determine the first height 13 and the second height 15, the two-wheeler pneumatic tire 1 can be curved upwards in terms of its cross section in such a way that the two carcass plies 6, 6′ emanating from the zenith 17 are disposed so as to be largely rectilinear in the region of the sidewall 3, and transition to a wrapping of the core 5 that is largely symmetrical in terms of the core 5. This can be a fragment of the tire of FIG. 1, wherein the two-wheeler pneumatic tire 1 is correspondingly curved upwards in terms of its cross section. In this arrangement, the first height 13 and the second height 15 are measured relative to the outermost turn-up point 14 of an outer edge of the strength members of the second carcass ply 6′ that are wrapped about the core 5, and measured parallel to the carcass plies 6, 6′ that are disposed to be substantially rectilinear in the region of the sidewall 3.

### LIST OF REFERENCE SIGNS

1 Two-wheeler pneumatic tire
2 Tread
3 Sidewall
4 Bead region
5 Core
6 First carcass ply
6′ Second carcass ply
7 First carcass ply end
7′ Second carcass ply end
8 Bead protection strip
9 Rubber ply
10 Tire interior
11 Tire exterior
12 Radially outer end of the bead protection strip
13 First height
14 Outermost turn-up point
15 Second height
16 Radially inner end of the bead protection strip
17 Zenith
18 First straight line
19 Second straight line
20 Axial half
21 Tread end
61 Carcass ply turn-up
rR Radial direction
aR Axial direction
U Revolving direction

1. A two-wheeler pneumatic tire comprising:
a tread a tire carcass, tire sidewalls and two bead regions each having a tire bead with a core, wherein the two bead regions have in each case a bead protection strip which as wear protection is disposed axially outside the carcass,
wherein the tire carcass is formed from a first carcass ply and a second carcass ply each having a strength member,
wherein the second carcass ply is disposed in a zenith of the two-wheeler pneumatic tire so as to be radially within the first carcass ply, and extends from the zenith of the two-wheeler pneumatic tire over the tire sidewalls into both bead regions, and in the latter wraps the respective core from axially inside to axially outside, and terminates in a second carcass ply end below the bead protection strip of the respective bead region,
wherein the first carcass ply extends from the zenith of the two-wheeler pneumatic tire over the tire sidewalls into the bead regions, and in the latter wraps the respective core from axially inside to axially outside,
wherein the first carcass ply leads from the respective bead region in a carcass ply turn-up over the respective tire sidewall and under the tread, and
wherein the two carcass ply turn-ups are disposed in the zenith of the tire so as to overlap one another, characterized in that the carcass ply turn-ups extend over the zenith and the tire sidewalls into both bead regions, and in the latter terminate below the bead protection strip in a first carcass ply end.

2. The two-wheeler pneumatic tire as claimed in claim 1, wherein the tire has two axial halves, and in that in each of the axial halves a carcass ply turn-up extending from the bead region in the direction of the zenith, and a carcass ply turn-up extending from the zenith to the carcass ply end, are in each case disposed so as to overlap one another in the region of the tire sidewalls.

3. The two-wheeler pneumatic tire as claimed in claim 1, wherein the first carcass ply ends terminate in the bead regions below the second carcass ply ends.

4. The two-wheeler pneumatic tire as claimed in claim 1, wherein the bead protection strip terminates in a radially outer end at a first height of at most 15 mm, preferably of 10 mm to 12 mm, measured relative to an outermost turn-up point of the strength members of the second carcass ply that are wrapped about the core.

5. The two-wheeler pneumatic tire as claimed in claim 1, wherein the bead protection strip is embodied as a rubberized woven monofilament fabric.

6. The two-wheeler pneumatic tire as claimed in claim 1, wherein the carcass is in direct contact with a tire interior.

7. The two-wheeler pneumatic tire as claimed in claim 1, wherein the tire is a tube-free tire in particular a “tubeless” tire or a “tubeless-ready” tire.

8. The two-wheeler pneumatic tire as claimed in claim 1, wherein the tire is a bicycle tire for operation with a tube, in particular a clincher tire.

9. The two-wheeler pneumatic tire as claimed in claim 1, wherein at least in one region of the sidewall, the first carcass ply and the second carcass ply are the only plies with strength members.

10. The two-wheeler pneumatic tire as claimed in claim 1, wherein a damping rubber ply from a highly elastic natural rubber is disposed between the tread and the tire carcass, wherein the damping rubber ply has a material thickness between 0.2 mm and 1 mm.

11. The two-wheeler pneumatic tire as claimed in claim 1, wherein a protective ply from a particularly tear-resistant rubberized woven fabric, comprises fibers of polyethylene terephthalate polyacrylate, or from a rubber layer, is disposed between the tread and the tire carcass.

12. The two-wheeler pneumatic tire as claimed in claim 1, wherein the two-wheeler pneumatic tire is a racing bike tire a mountain bike tire, or a tire for a bicycle having an electric motor for driving the bicycle.

13. A two-wheeler pneumatic tire comprising:
a tread;
a tire carcass formed from a first carcass ply and a second carcass ply, each having a strength member;
tire sidewalls; and
two bead regions having a tire bead with a core, wherein the two bead regions have a bead protection strip as wear protection and the bead protection strip is disposed axially outside the carcass;
the first carcass ply leads from the respective bead region in a carcass ply turn-up over the respective tire sidewall below the tread, and from there over the opposite sidewall into the contiguous bead region to a first carcass ply end, and there terminates in the respective first carcass ply end below the bead protection strip;
the second carcass ply terminates in its second carcass ply ends also below the bead protection strip, and thus does not lead from the respective bead region over the tire sidewalls to below the tread; and
four plies of the carcass plies are continuously present in the sidewall as well as below the tread, formed by an overlapping arrangement of the first and second carcass plies and two further plies formed by the carcass turn-ups.

14. The two-wheeler pneumatic tire of claim 13, wherein the second carcass ply is disposed in a zenith of the two-wheeler pneumatic tire to be radially within the first carcass ply, and extends from the zenith of the two-wheeler pneumatic tire over the tire sidewalls into both bead regions, and in the latter wraps the respective core from axially inside to axially outside, and terminates in a second carcass ply end below the bead protection strip of the respective bead region.

15. The two-wheeler pneumatic tire of claim 13, wherein the first carcass ply extends from the zenith of the two-wheeler pneumatic tire over the tire sidewalls into the bead regions, and in the latter wraps the respective core from axially inside to axially outside, wherein the first carcass ply leads from the respective bead region in a carcass ply turn-up over the respective tire sidewall and under the tread, and. wherein the two carcass ply turn-ups are disposed in the zenith of the tire so as to overlap one another, characterized in that the carcass ply turn-ups extend over the zenith and the tire sidewalls into both bead regions, and in the latter terminate below the bead protection strip in a first carcass ply end.

16. The two-wheeler pneumatic tire as claimed in claim 13, wherein the tire has two axial halves, and in that in each of the axial halves a carcass ply turn-up extending from the bead region in the direction of the zenith, and a carcass ply turn-up extending from the zenith to the carcass ply end, are in each case disposed so as to overlap one another in the region of the tire sidewalls.

17. The two-wheeler pneumatic tire as claimed in claim 13, wherein the first carcass ply ends terminate in the bead regions below the second carcass ply ends.

18. The two-wheeler pneumatic tire as claimed in claim 13, wherein the first carcass ply improves durability and puncture resistance due to its ends disposed below the beat protection strip.

19. A two-wheeler pneumatic tire comprising:
a tread;
a tire carcass formed from a first carcass ply and a second carcass;
tire sidewalls; and
two bead regions having a tire bead with a core, wherein the two bead regions have a bead protection strip as wear protection and the bead protection strip is disposed axially outside the carcass;
the first carcass ply leads from the respective bead region in a carcass ply turn-up over the respective tire sidewall below the tread, and from there over the opposite sidewall into the contiguous bead region to a first carcass ply end, and there terminates in the respective first carcass ply end below the bead protection strip;
the second carcass ply terminates in its second carcass ply ends also below the bead protection strip, and thus does not lead from the respective bead region over the tire sidewalls to below the tread; and
four plies of the carcass plies are continuously present in the sidewall as well as below the tread, formed by an overlapping arrangement of the first and second carcass plies and two further plies formed by the carcass turn-ups.

20. The two-wheeler pneumatic tire as claimed in claim 19, further comprising a damping rubber play from a relatively high elastic natural rubber disposed between the tread and the carcass and the damping rubber ply has a material thickness between 0.2 mm and 1 mm and the relatively high elastic natural rubber has a material rebound value between 70 and 80 and is configured to adapt to a road surface and simultaneously increase the rolling resistance.
